(19) United States
(12) Patent Application Publication
(10) Pub. No.: US 2025/0249641 A1
(43) Pub. Date: Aug. 7, 2025

(54) CALIBRATION TOOL FOR THREE-DIMENSIONAL PRINTING SYSTEM

(71) Applicants: NISSAN NORTH AMERICA, INC., Franklin, TN (US); NORTHWESTERN UNIVERSITY, Evanston, IL (US); ECOLE DE TECHNOLOGIE SUPERIEURE, Montreal (CA)

(72) Inventors: Ilian BONEV, Saint-Lambert (CA); Cheng SUN, Wilmette, IL (US); Pengpeng ZHANG, Evanston, IL (US); Yasser KRIM, Montreal (CA); Evan JONES, Evanston, IL (US); Nanzhu ZHAO, NOVI, MI (US)

(21) Appl. No.: 18/430,275

(22) Filed: Feb. 1, 2024

(51) Int. Cl. B29C 64/393; B29C 64/124; B29C 64/307; B33Y 30/00; B33Y 50/02

(52) U.S. Cl. CPC B29C 64/393; B29C 64/124; B29C 64/307; B33Y 30/00; B33Y 50/02

(57) ABSTRACT

A three-dimensional printing system includes a tank, an arm, a rigid base, a light source, and a calibration tool. The tank contains a liquid photopolymer resin. The arm is configured to be movable relative to the tank. The rigid base is connected to the arm. The light source is configured to emit light to the tank to form an object on the rigid base. The calibration tool is connected to the tank. The calibration tool is configured to calibrate at least one of the tank and the arm.

### BACKGROUND

### Technical Field

The present disclosure generally relates to a three-dimensional printing system. More specifically, the present disclosure relates to a three-dimensional printing system including a calibration tool configured to facilitate calibration of a component of the three-dimensional printing system.

### Background Information

Three-dimensional (3D) printing is the construction of a three-dimensional object from a digital file, such as a CAD model or a digital 3D model. The objects are printed layer by layer by the 3D printing system by curing portions of a light curable photopolymer resin layer by layer, one layer at a time, within a printing area of a tank filled with the photopolymer resin. A curing device, such as an ultraviolet light source, is projected through a transparent substrate or bottom wall of the tank curing each layer of the object on a build plate, or rigid base, that is initially at least partially submerged within the photopolymer resin. The build plate is incrementally raised upward as each layer is cured thereon.

The build plate is connected to a robotic arm. The robotic arm facilitates repeating the three-dimensional printing process, but the position and orientation, or pose, of the robotic arm can be inaccurate. The robotic arm being in an incorrect position and/or pose can also lead to misalignment between the robotic arm and the resin tank. Inaccuracies and misalignments during the printing process can result in printed objects differing from the CAD model and having defects.

### SUMMARY

A need exists for an improved three-dimensional printing system in which a calibration tool facilitates calibration of a component of the three-dimensional printing system.

In view of the state of the known technology, one aspect of the present disclosure is to provide a three-dimensional printing system including a tank, an arm, a rigid base, a light source, and a calibration tool. The tank contains a liquid photopolymer resin. The arm is configured to be movable relative to the tank. The rigid base is connected to the arm. The light source is configured to emit light to the tank to form an object on the rigid base. The calibration tool is connected to the tank. The calibration tool is configured to calibrate at least one of the tank and the arm.

Also other objects, features, aspects and advantages of the disclosed calibration tool for a three-dimensional printing system will become apparent to those skilled in the art from the following detailed description, which, taken in conjunction with the annexed drawings, discloses exemplary embodiments of a calibration tool for a three-dimensional printing system.

### BRIEF DESCRIPTION OF THE DRAWINGS

Referring now to the attached drawings which form a part of this original disclosure:

FIG. 1 is a perspective view of a three-dimensional printing system in accordance with an exemplary embodiment;

FIG. 2 is a perspective view in which a calibration support member is connected to an arm and a calibration plate and an alignment actuator are connected to a tank of the three-dimensional printing system of FIG. 1;

FIG. 3 is a perspective view of an alignment actuator of the three-dimensional printing system of FIG. 2;

FIG. 4 is a perspective view of the calibration support member of FIG. 2;

FIG. 5 is a perspective view of the calibration plate of FIG. 2 connected to the tank;

FIG. 6 is a perspective view of the calibration plate of FIG. 5 removed from the tank;

FIG. 7 is a perspective view of the tank of the three-dimensional printing system of FIG. 1;

FIG. 8 is a perspective view of the three-dimensional printing system of FIG. 1 in which an actuator is connected to the tank;

FIG. 9 is a perspective view of the three-dimensional printing system of FIG. 8 in which a camera is connected to the arm;

FIG. 10 is a perspective view of the three-dimensional printing system of FIG. 8 in which the arm moves to a base station to engage a rigid base;

FIG. 11 is a perspective view of the three-dimensional printing system of FIG. 10 in which an object is formed on the engaged rigid base;

FIG. 12 is a perspective view of the three-dimensional printing system of FIG. 11 in which the printed object is moved to a first post-processing station;

FIG. 13 is a perspective view of the three-dimensional printing system of FIG. 12 in which the printed object is moved to a second post-processing station;

FIG. 14 is a perspective view of the three-dimensional printing system of FIG. 13 in which the printed object is moved to the base station; and

FIG. 15 is a perspective view of a platform on which the three-dimensional printing system of FIG. 8 is disposed.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

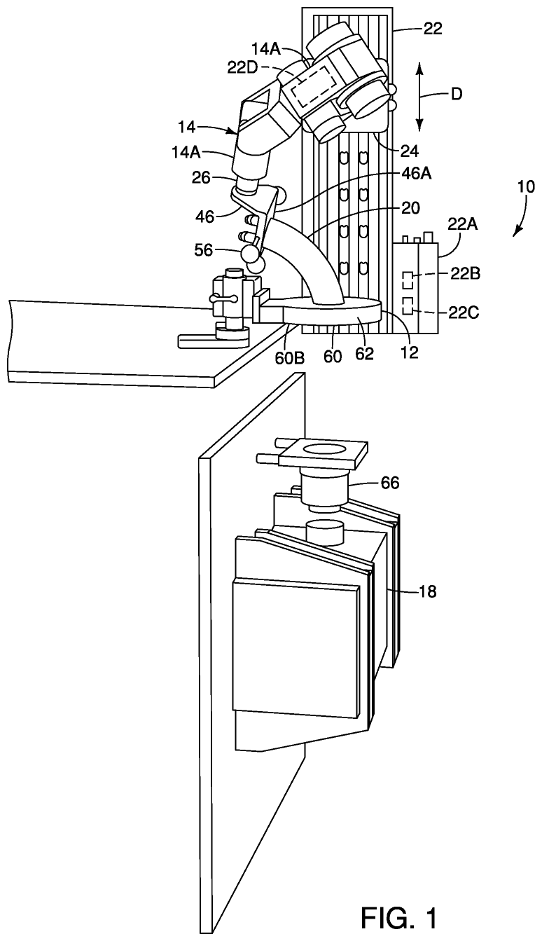

Referring initially to FIG. 1, a three-dimensional printing system 10 in accordance with an exemplary embodiment includes a tank 12 configured to contain a liquid photopolymer resin, as shown in FIG. 1. A control arm 14 is configured to be movable relative to the tank 12. A rigid base 16 is connected to the arm 14, as shown in FIG. 11. A light source 18 is configured to emit light to the tank 12 to form a printed object 20 on the rigid base 16.

A guide rail 22 is mounted externally of the tank 12, as shown in FIG. 1. The arm 14 is configured to move linearly in a direction D along the guide rail 22. The guide rail 22 can include an integrated linear motor, or any other suitable means of moving the arm 14 along the guide rail 22, and a controller 22BA configured to control linear movement of the arm 14 along the guide rail 22. The controller 22B can be disposed in a housing 22A disposed adjacent to the guide rail 22. The controller 22B can control movement of the arm 14 along the guide rail 22. The arm 14 includes a slide 24 connected to the guide rail 22. The slide 24 is configured to move in the direction D along the guide 023-08 US rail 22. In other words, the slide 24 moves linearly along the guide rail 22 to position the arm 14 relative to the tank 12. The slide 24 is configured for precise linear movement along the guide rail 22 with high accuracy. The arm 14 is configured to be movable relative to the tank 12 along the guide rail 22 to control movement of the rigid base 16. The guide rail 22 increases a work region of the arm 14 to facilitate printing elongated and complex objects. The linear movement of the base 24 and the arm 14 are controlled during the printing process in accordance with the digital file for the object to be printed. A controller 22D controls movement of the arm 16. The controller 22D can be disposed in the arm 16, as shown in FIG. 1, or located externally.

The control arm 14 is connected to the rigid base 16 to control movement and positioning of the rigid base 16 during the printing process. The control arm 14 is connected to the rigid base 16 to move the rigid base 16 relative to the tank 12 during the printing process. The control arm 14 includes a plurality of links 14A independently movable relative to each other to provide highly accurate positioning of the rigid base 16. The control arm 14 preferably has six degrees of freedom, such that the rigid base 14 can move through a curvilinear path to more accurately print the object 20. The control arm 14 is preferably a robotic arm having six degrees of freedom. The six degrees of freedom are movements along the three axes (i.e., the X, Y and Z axes), and rotation about each of the three axes (i.e., pitch, roll and yaw). Providing the control arm 14 with multiple degrees of freedom, such as six degrees of freedom, allows the control arm 14 to move the rigid base 16 through a curvilinear path, including moving the rigid base 16 to a plurality of positions, thereby allowing a more accurate and intricate object 20 to be printed.

A tool adapter 26 is configured to be connected to the arm 14, as shown in FIGS. 1, 2 and 4. The tool adapter 26 is removably connected to one of the links 14A of the arm 14 in any suitable manner. Preferably, the tool adapter 26 is connected to the link 14A farthest from the slide 24. The tool adapter 26 facilitates removably connecting a plurality of components to the arm 14. The components are removably connected to the tool adapter 26 in any suitable manner.

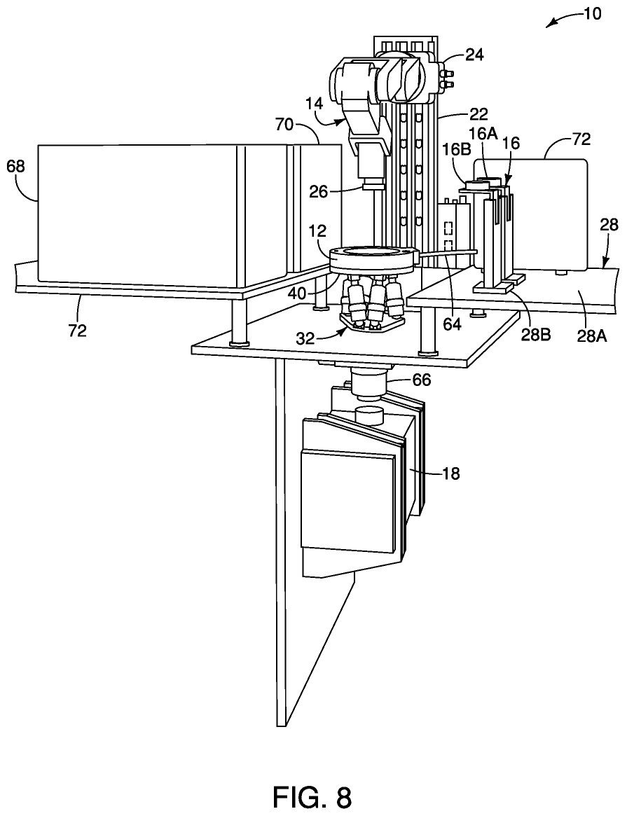

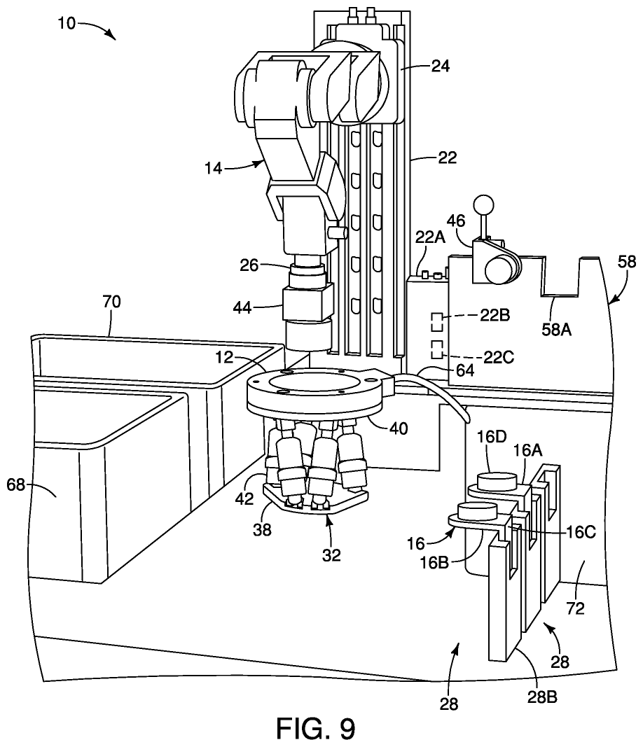

A rigid base station 28 is disposed proximate to the tank 12, as shown in FIGS. 8 and 9. The rigid base station 28 includes a plurality of rigid bases 16A and 16B. Each of the rigid bases is configured to be removably connected to the tool adapter 26. Each of the rigid bases 16A and 16B is configured to be automatically connected to and removed from the tool adapter 26. The rigid base station 28 includes a platform 28A on which a plurality of rigid base supports 28B are mounted. The rigid base support 28B is configured to removably receive the rigid base 16.

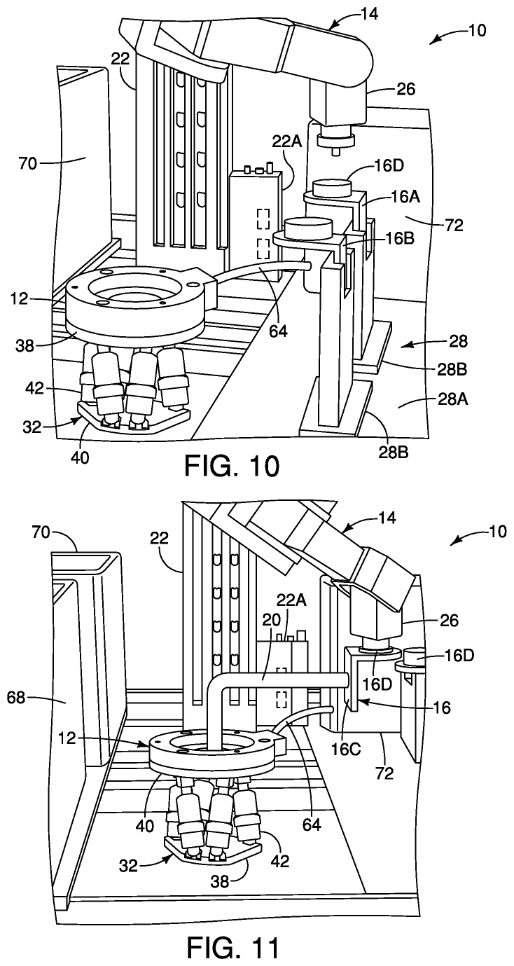

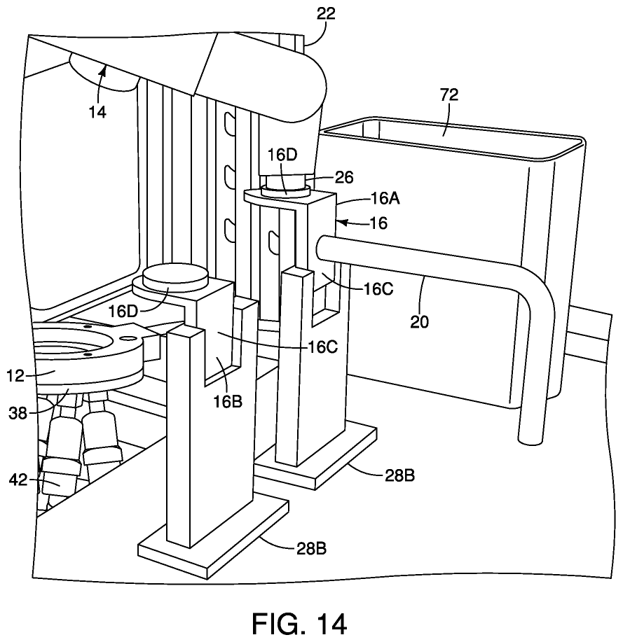

The print control program controls operation of the arm 14 to move the arm 14 to the rigid base station 28 to connect and remove the rigid base 16 from the rigid base support 28B, as shown in FIGS. 9 and 10. The first rigid base 16A is connected to the tool adapter 26 to print a first object, as shown in FIG. 10. When the first object 20 is printed, the first rigid base 16A is removed from the tool adapter 26 and a second rigid base 16B is connected to the tool adapter 26 to print a second object. The first rigid base 16A is returned to the rigid base support 28A, as shown in FIG. 14, and the second rigid base 16B is attached to the tool adapter 26 of the arm 14. A printed object can be repeatedly printed by storing a plurality of rigid bases 16 at the rigid base station 28. Each of the rigid bases 16 is configured to be removed from the tool adapter 26 with the printed object attached to the rigid base 16, as shown in FIG. 14.

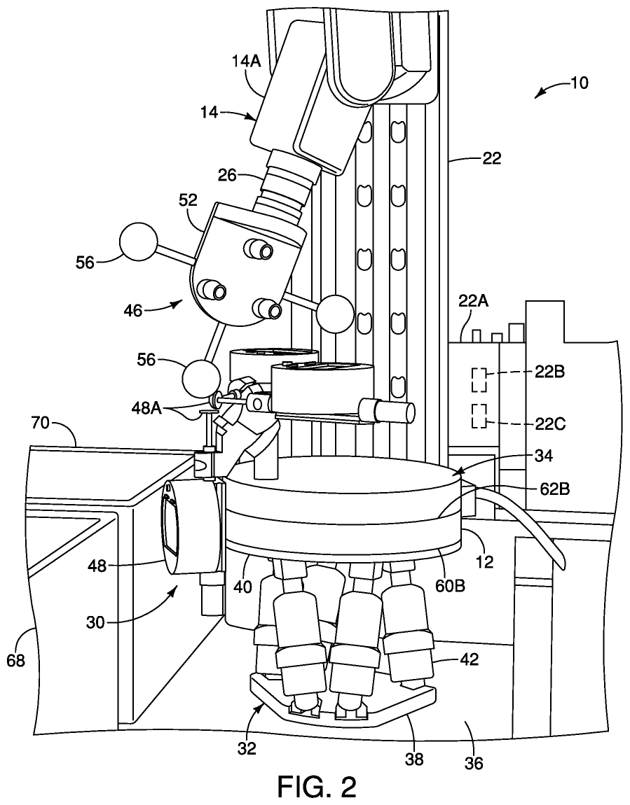

A calibration tool 30 is connected to the tank 12, as shown in FIG. 2. The calibration tool 30 is configured to align the tank 12 and/or the arm 14. The calibration tool 30 includes at least one of an alignment actuator 32 and a calibration plate 34.

The alignment actuator 32 is connected to the tank 12, as shown in FIG. 2. The tank 12 is connected to a platform 36. The actuator 32 is disposed between the platform 36 and the tank 12. The calibration process with the actuator 32 is configured to adjust a position of the tank 12 with respect to the light source 18.

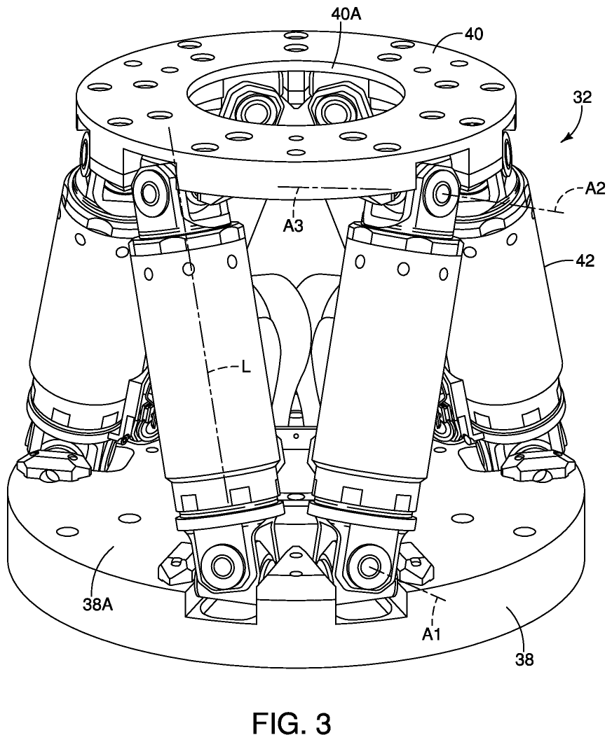

The actuator 32 includes a lower base 38, an upper base 40 and a plurality of legs 42 extending between the lower base 38 and the upper base 40, as shown in FIGS. 2 and 3. The lower base 38 is connected to the platform 36. The upper base 38 is connected to the tank 12. As shown in FIG. 2, the upper base 38 is connected to a lower surface 60B of a base 60 of the tank 12. The lower base 38 has a first opening 38A and the upper base 38 has a second opening 40A. The first opening 38A is aligned with the second opening 40A such that the light emitted by the light source 18 passes through the alignment actuator 32 to the tank 12. In other words, the light source 18 is configured to emit light to the tank 12 through the first opening 38A and the second opening 40A in the alignment actuator 32. The alignment actuator 32 facilitates precisely adjusting the orientation and position of the tank 12 with respect to the light source 18. The alignment actuator 32 reduces misalignment between the resin tank 12 and the light source 18.

The actuator 32 preferably has at least three legs 42, as shown in FIG. 2. More preferably, the actuator 32 has six legs 42. Each of the legs 42 is movable along a longitudinal axis L of the leg 42. Each of the plurality of legs 42 has a first member 42A and a second member 42B movable relative to one another to facilitate movement of each leg along the longitudinal axis L thereof. Each of the legs 42 is rotatable about a first axis A1, as shown in FIG. 3. Each of the legs is rotatable about a second axis A2. Each of the legs 42 is rotatable about a third axis A3. The third axis A3 is different from the second axis A2, which is different from the first axis A1. In other words, each of the axes A1, A2 and A3 is different. The actuator 32 is connected to an electronic controller 22C, as shown in FIG. 2, to control movement of each of the plurality of legs 42, thereby providing precise positioning of the tank 12. The actuator 32 allows positioning of the tank 12 about six axes (the X, Y and Z axes, and pitch, roll and yaw).

As shown in FIGS. 7 and 8, a camera 44 is removably connected to the tool adapter 26 connected to the arm 14. In other words, the camera 44 is configured to be removably connected to the arm 14. The camera 44 is connected to the arm 14 when the rigid base 16 is not connected to the arm 14. The camera 44 can be removed from the tool adapter 26 to connect a rigid base 16 to the tool adapter 26. The camera 44 is configured to detect a first position of the tank 12 and a second position of the light source 18 when the camera is connected to the arm 14. The camera 44 transmits the first and second positions to the electronic controller 22C (FIG. 2). The electronic controller 22C transmits a control signal to the actuator 32 to move each of the plurality of legs 42 to align the tank 12. In other words, the actuator 32 is configured to adjust the first position of the tank 12 based on the detected first and second positions. The actuator 32 is rigid and stable when not adjusting a position of the tank 12, such that the tank 12 is substantially fixed in the position set by the actuator 32. The camera 44 identifies the position of the focal plane of the light source 18 to reduce misalignment between the tank 12 and the light source 18.

The calibration plate 34 is removably connected to the tank 12, as shown in FIG. 2. The calibration plate 34 is connected to an upper surface 62B of a wall 62 of the tank 12. The calibration plate 34 is connected to the tank 12 when an object is not being printed by the three-dimensional printing system 10. A calibration support member 46 is removably connected to the tool adapter 26 of the arm 14. As shown in FIG. 2, the alignment actuator 32 and the calibration plate 34 can be connected to opposite sides of the tank 12 at the same time.

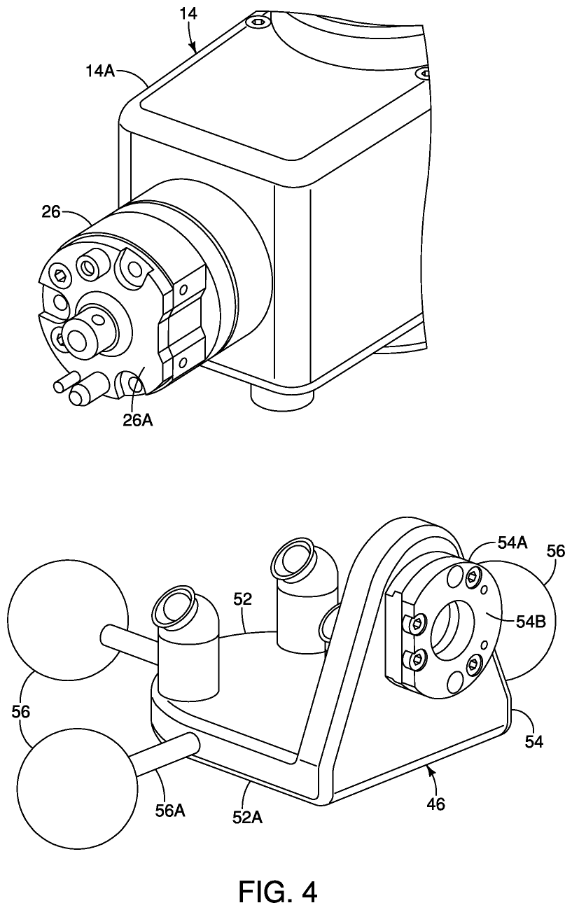

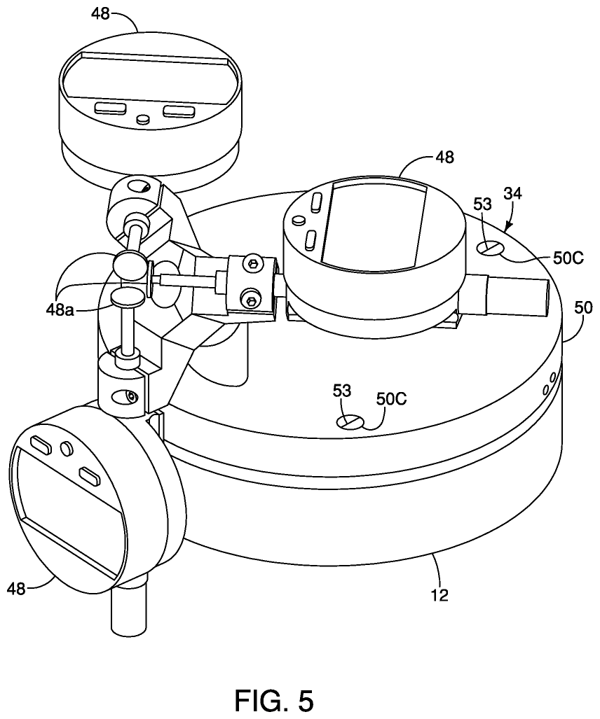

The calibration plate 34 includes a plurality of linear displacement sensors 48 fixed to a base 50 of the calibration plate 34, as shown in FIGS. 2, 5 and 6. The calibration plate 34 includes three linear displacement sensors 48, although any suitable number of linear displacement sensors can be used. Each of the linear displacement sensors 48 includes a plate 48A. The plates 48A define a socket, or contact surface, in which a datum ball 56 is received and configured to push the plates 48A. Each of the plates 48A is disposed on a different axis that is substantially perpendicular to the axes of the other plates 48A, as shown in FIG. 5. The base 50 and the linear displacement sensors 48A form a three-dimensional probe facilitating measurement of a relative position of a datum ball 56 (FIG. 4) disposed in the socket. Alternatively, the three-dimensional probe can measure the relative position of the datum ball 56 in any suitable manner, such as with non-contact capacitive sensors.

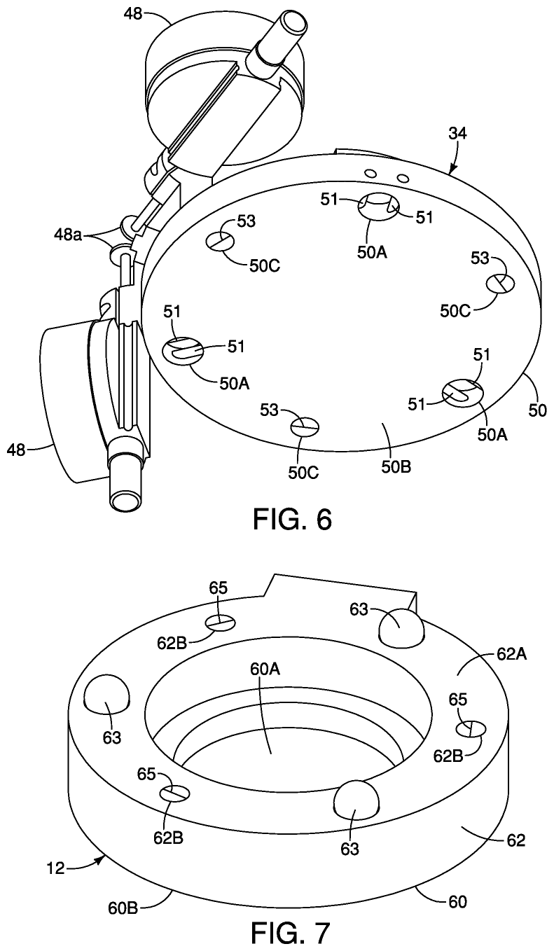

Referring to FIGS. 6 and 7, the calibration plate 32 is kinematically coupled to the tank 12. The kinematic coupling facilitates attaching the calibration plate 32 to the tank 12 in a highly repeatably manner in a plurality of positions. As shown in FIG. 7, a plurality of openings 50A are disposed in a lower surface 50B of the base 50. Three openings 50A are illustrated in FIG. 6, although the base 50 of the calibration plate 34 can have any suitable number.

A pair of cylindrical, or dowel, pins 51, are disposed in each of the openings 50A in the calibration plate 34, as shown in FIG. 6. The pair of pins 51 are preferably substantially parallel to each other. The pins 51 preferably extend in the radial direction. The pins 51 preferably extend in a direction substantially parallel to a longitudinal axis of the opening 50A. The pair of pins 51 form a V-shaped groove configured to receive a spherical member 63 of the tank 12. A plurality of magnets 53 can be disposed in the lower surface 50B of the calibration plate 34. Each magnet 53 is circumferentially disposed between two of the openings 50A. In other words, the calibration plate 34 has the same number of magnets 53 as pairs of dowel pins 51, although any suitable number of magnets 53 can be used. The magnets 53 can be disposed in the lower surface 50B in any suitable manner, such as threadedly engaging each magnet in a threaded hole 50C.

As shown in FIG. 7, a plurality of spherical members 63 are disposed on the upper surface 62A of a wall 62 of the tank 12. The spherical members 63 are configured to align with the openings 50A of the calibration plate 34 to allow the calibration plate 34 to be connected to the tank 12 in a plurality of positions. Each V-shaped groove defined by a pair of dowel pins 51 receives one of the spherical members 63 of the tank 12 to form the kinematic coupling therebetween. The spherical member 63 can be connected to the upper surface 62A of the wall 62 in any suitable manner. A threaded post can extend from the upper surface 62A of the wall 62, and the spherical member 63 can be threadedly connected to the threaded post.

A plurality of magnets 65 can be disposed in the upper surface 62A of the wall 62 of the tank 12, as shown in FIG. 7. Each magnet 65 is circumferentially disposed between two of the spherical members 63. In other words, the tank 12 has the same number of magnets 65 as spherical members 63, although any suitable number of magnets 65 can be used. The magnets 65 can be disposed in the upper surface 62A in any suitable manner, such as threadedly engaging each magnet 65 in a threaded hole 62B.

When the calibration plate 34 is disposed on top of the tank 12, in one of the three possible orientations, each of spherical members 63 contacts one of the V-shaped grooves defined by the pair of dowel pins 51 in exactly two points. The total of six contact points between the calibration place 34 and tank 12 insure a highly repeatable mating. To increase stability, three magnets 53 are disposed on the bottom surface 50B of the base 50 of the calibration plate 34, and three corresponding magnets 65 are fixed on the upper surface 62A of the wall 62 of the tank 12. When the calibration plate 34 is kinematically coupled to the tank 12, each pair of opposing magnets 53 and 65 are aligned with opposite poles at an adjustable distance.

The calibration support member 46 is removably connected to the tool adapter 26 of the arm 14, as shown in FIG. 2. The calibration support member 46 includes a base 52, as shown in FIG. 4. The base 52 includes a substantially planar printing surface 52A such that the calibration support member 46 can also function as a rigid base upon which an object is printed. A wall 54 extends from the base 52 of the calibration support member 46. A connecting member 54A is disposed on the wall 54. The connecting member 54A is configured to be removably connected to the tool adapter 26. A face 54B of the connecting member 54A contacts a face 26A of the tool adapter 26 when the calibration support member 46 is connected to the tool adapter 26.

A plurality of datum balls 56 are connected to the base 52 of the calibration support member 46, as shown in FIGS. 2 and 4. During a calibration process of the arm 14, the arm 14 moves each of the datum balls 56 into the socket formed by the plates 48A. The datum ball 56 is positioned such that the datum ball 56 contacts each of the three plates 48A. The position of the socket is known, such that the detected position of the datum ball 56 received in the socket can be used to calibrate the arm 14. The linear displacement sensors 48 detect the position of each of the datum balls 56 in the socket to detect a position of the calibration support member 46 to determine the position of the arm 14. In other words, the calibration support member 46 is moved with respect to the calibration plate 34 to detect a position of the calibration support member 46 to calibrate the arm 14. By changing the position of the calibration plate 34 on the tank 12, additional positions of the datum balls 56 can be detected, thereby increasing the accuracy of the calibration of the arm 14. In other words, the calibration plate 34 is attachable to the tank 12 in a plurality of positions to increase a number of positions of the calibration support member 46 measurable with respect to the calibration plate 34. A conventional method can be used to calibrate the arm 14 based on the detected positions of the datum balls 56.

During the calibration process with the calibration plate 34, one of the datum balls 56 is moved to the socket to contact each of the plates 48A, as shown in FIG. 2. Each of the linear displacement sensors 48 measures the position of the datum ball 56, and transmits a signal to a computer. The computer transmits a signal to the controller 22D for the arm 22 to move the arm 14 to move the datum ball 56. This process is repeated until each of the linear displacement sensors 48 measures a displacement that is less than a predetermined threshold. Any suitable threshold can be used, such as a displacement of 10 micrometers or 0 micrometers. This process is repeated for the other datum balls 56 of the calibration support member 46 with the calibration plate 34 disposed in a first position. The calibration plate is then moved to a second position, approximately 120 degrees offset from the first position, and the process is repeated for each of the datum balls. The calibration plate 34 is then moved to a third position, and the process is repeated again. The calibration process with the calibration plate 34 and the calibration support member 46 calibrates the arm 14 and the guide rail 22, and identifies a position of the tank 12 with respect to the guide rail 22. The calibration process with the calibration plate 34 and the calibration support member 46 can be performed after the calibration process with the alignment actuator 32 to identify a new position of the tank 12 with respect to the guide rail 22.

After the arm 14 has been calibrated, the calibration support member 46 is automatically removed from the tool adapter 26 and returned to a tool station 58, as shown in FIG. 9. The tool station 58 includes a plurality of slots 58A configured to removably receive a tool. Another tool, such as the camera 44 or the rigid base 16, can then be automatically connected to the tool adapter 26. The camera 44 can be returned to one slot 58A of the tool station 58, and the arm 14 can pick up the calibration support member 46 or one of the rigid bases 16 after returning the camera 44. The calibration of the arm 14 prior to a printing operation reduces the low positional accuracy of the arm 14.

As shown in FIG. 7, the tank 12 contains a liquid photopolymer resin. The tank 12 can be any suitable shape to hold the liquid polymer resin therein, such as rectangular or circular. The tank 12 has a base 60 and a side wall 62 extending upwardly from the base 60. The base 60 is preferably transparent such that the light emitted from the light source 18 can pass through the base 60. The entirety of the base 60 can be transparent, or a portion of the base 60 can be transparent. The transparent portion of the base 60 constitutes an optically transparent window 60A through which the emitted light from the light source 18 can pass. A pipe 64 can be connected to the tank 12, as shown in FIG. 9, to supply additional liquid photopolymer resin to the tank 12 to allow for continuous printing of a plurality of objects. A plurality of openings 62A are disposed in the upper surface 62B of the wall 62 of the tank 12. The openings 62A are configured to align with the openings 50A of the calibration plate 34 to allow the calibration plate 34 to be connected to the tank 12 in a plurality of positions.

The rigid base 16 provides the print surface 16C on which the object 20 is printed, as shown in FIGS. 1 and 11. The print surface 16C is preferably a planar surface, as shown in FIG. 9. The rigid base 16 can be made of any suitable material, such as plastic, such as polyactic acid (PLA), or glass. The rigid base 16 includes a connecting member 16D configured to be removably connected to the tool adapter 26 in any suitable manner.

The liquid polymer resin is selectively cured by light-activated polymerization, such as by photopolymerization, which preferably uses visible or UV light, although light having any suitable wavelength can be used, to form in situ cross-linked polymer structures. The liquid photopolymer resin preferably includes monomer and oligomer molecules that are converted to solid polymers during photopolymerization when the light emitted by the light source 18 is guided through the transparent portion, or the optically transparent window 60A, of the base 60 of the tank 12. The supply pipe 64 connected to the tank 12, as shown in FIGS. 8 and 9, supplies additional liquid photopolymer resin to the tank 12 to allow for continuous printing of a plurality of objects. The supply pipe 64 is fluidly connected between the tank 12 and a refuel tank 72, as shown in FIGS. 8 and 9. The refuel tank 72 stores liquid photopolymer resin to be supplied to the tank 12. In other words, the refuel tank 72 is fluidly connected to the tank 12 to supply liquid photopolymer resin to the tank 12.

The light source 18 emits light to cure the liquid polymer resin in the tank 12, as shown in FIGS. 1 and 8. The light source 18 preferably emits UV light having a wavelength between approximately 10 and 400 nanometers, inclusive. Preferably, the emitted UV light has a wavelength between approximately 380 and 400 nanometers, inclusive. Light having any suitable wavelength can be used, such as, but not limited to, UV, visible and infrared light. The light emitted by the light source 18 is configured to pass through the openings 38A and 40A of the actuator 32, as shown in FIGS. 3 and 11, and through the transparent window 60A of the tank 12 to solidify the liquid photopolymer resin layer by layer on the rigid base 16.

As shown in FIGS. 1 and 8, a lens 66 can be disposed between the light source 18 and the tank 12. The lens 66 is configured to adjust a resolution of the emitted light. The lens 66 is selected based on a desired focal depth.

As shown in FIGS. 8 and 9, the 3D printing system 10 can include any suitable number of post-processing stations. The 3D printing system 10 preferably includes a first post-processing station 68 and a second post-processing station 70. The post-processing stations further process the printed object 20 after the printed object 20 is removed from the tank 12, such as washing and curing the printed object. The printed object 20 passes through the first post-processing station 68 and the second post-processing station 70 while the printed object 20 is still connected to the rigid base 16, which is still connected to the arm 14. The first post-processing station 68 is preferably a curing station, and the second post-processing station 70 is preferably a washing station. The first and second post-processing stations 68 and 70 are preferably disposed on the same platform 72, as shown in FIG. 8. The printed object 20 is processed at the post-processing stations while still attached to the arm 14.

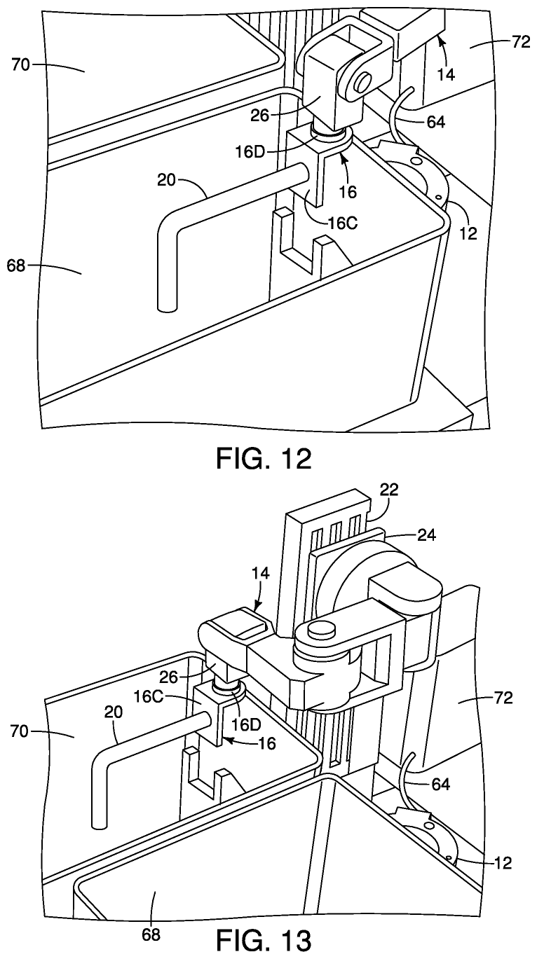

The first post-processing station 68, as shown in FIGS. 1, 2, 8 and 9, is a post-washing station configured to wash the printed object 20 externally of the tank 12. Post-washing removes any residual, uncured resin from the printed object 20. The first post-processing station 68 is disposed adjacent to the tank 12. The arm 14 is configured to dispose the printed object 20 in the first post-processing station 68 prior to removing the rigid base 16 from the tool adapter 26, as shown in FIG. 12.

The second post-processing station 70, as shown in FIGS. 1, 2, 8 and 8, is a post-curing station configured to further cure the printed object 20 externally of the tank 12. Post-curing facilitates the polymerization process to ensure the resin of the printed object 20 is fully cured. The second post-processing station 70 is disposed adjacent to the tank 12. The arm 14 is configured to dispose the printed object 20 in the second post-processing station 70 prior to removing the rigid base 16 from the tool adapter 26, as shown in FIG. 13. The arm 14 is preferably configured to dispose the printed object 20 in the second post-processing station 70 after the first post-processing station 68.

The second post-processing station 70, as shown in FIGS. 1, 2, 8 and 9, is a post-washing station configured to wash the printed object 20 externally of the tank 12. Post-washing removes any residual, uncured resin from the printed object 20.

After post-processing of the printed object 20, the arm 14 returns the rigid base to the rigid base support 28B, as shown in FIG. 14. The tool adapter 26 releases the first rigid base 16A. The arm 14 then picks up the second rigid base 16B with the tool adapter 26 to print another object.

As shown in FIGS. 8 and 9, the alignment actuator 32 can be used to calibrate the tank 12 relative to the light source 18. The arm 14 picks up the camera 44 from the tool station 58 to calibrate the tank 12. The camera 44 detects the first position of the tank 12 and the second position of the light source 18. The alignment actuator 32 adjusts the first position of the tank 12, as shown in FIG. 9, to identify the focal plane of the light source 18 and to precisely adjust the orientation and position of the tank 12.

After calibrating the tank 12, the arm 14 automatically returns the camera 44 to the tool station 58 and picks up the calibration support member 46 to calibrate the arm 14 and the guide rail 22. The calibration plate 34 is kinematically coupled to the tank 12, as shown in FIG. 2. The calibration plate 34 is kinematically coupled to the tank 12 in a plurality of positions to increase the data for calibrating the arm 14 and the guide rail 22. Following calibration of the arm 14 and the guide rail 22, the arm 14 returns the tool support member 46 to the tool station 58, and picks up one of these rigid bases 16. The calibration plate 34 is removed from the tank 12. In other words, the calibration support member 46 is automatically removed from the tool adapter 26 and returned to the tool station 58, and another tool or rigid base is automatically connected to the tool adapter 26.

The arm 14 can then be controlled to pick up the first rigid base 16A, as shown in FIG. 10. In other words, one of the plurality of rigid bases 16 is automatically connected to the tool adapter 26 after automatically removing the calibration support member 46 or the camera 44. The tool adapter 26 connects to the connecting member 16D of the rigid base 16 to secure the rigid base 16 to the arm 14. The arm 14 moves the rigid base 16 to the tank 12 to print the object 20 on the printing surface 16C of the first rigid base 16A, as shown in FIG. 11. The alignment actuator 32 is further configured to adjust the first position of the tank 12 when the rigid base 16 is connected to the arm 14 to facilitate flow of the liquid polymer resin in the tank 12 during the printing process. Movement of the liquid polymer resin in the tank 12 during the printing process facilitates flow of the resin to substantially prevent the printed object from adhering to the transparent window of the tank 12.

When the object 20 is completely printed, the arm 14 moves the first rigid base 16A to the first post-processing station 68, as shown in FIG. 12. The first post-processing station 68 is a post-washing station configured to wash the printed object 20 externally of the tank 12. Post-washing removes any residual, uncured resin from the printed object 20. The arm 14 is configured to dispose the printed object 20 in the first post-processing station 68 prior to removing the first rigid base 16A from the tool adapter 26.

After the printed object 20 is post-processed at the first post-processing station 68, the arm 14 moves the first rigid base to the second post-processing station 70, as shown in FIG. 13. The second post-processing station 70 is a post-curing station configured to further cure the printed object 20 externally of the tank 12. Post-curing facilitates the polymerization process to ensure the resin of the printed object 20 is fully cured. The arm 14 is configured to dispose the printed object 20 in the second post-processing station 70 prior to removing the first rigid base 16A from the tool adapter 26.

After post-processing of the printed object 20 at the second post-processing station 70, the arm 14 returns the first rigid base 16A to the rigid base support 28B, as shown in FIG. 14. The tool adapter 26 releases the first rigid base 16A. The arm 14 is then controlled to pick up the second rigid base 16B with the tool adapter 26 to print another object.

The calibration processes can be performed as desired or required. The calibration processes can be performed before each print job, after a pre-determined number of print jobs, or at any other desired time.

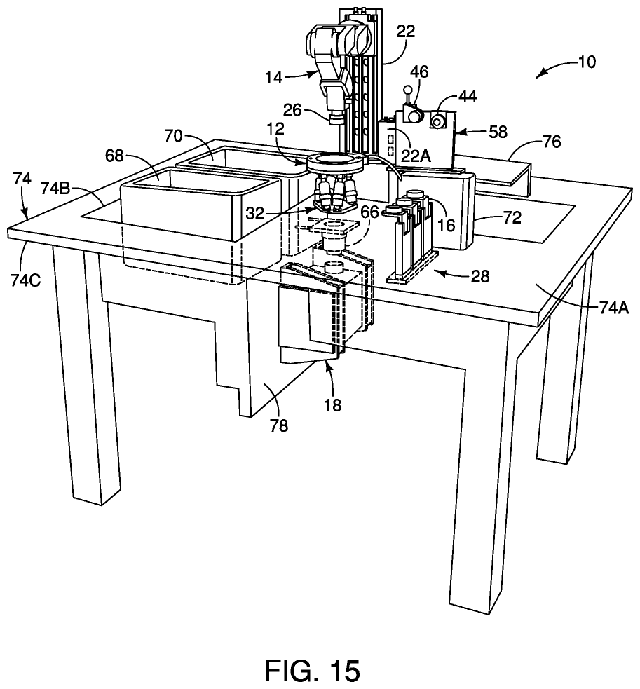

The 3D printing system 10 in accordance with an exemplary embodiment provides a system configured to calibrate the tank 12, the arm 14, and the guide rail 22, and to repeatedly print printed objects 20. As shown in FIG. 15, the 3D printing system 10 can be disposed on a single table 74. The rigid base station 28 and the alignment actuator 32 is disposed on an upper surface 74A of the table 74. The first and second post-processing station 68 and 70 are disposed in recesses 74B in the upper surface 74A of the table 74. The guide rail 22 and the tool station 58 are mounted on a shelf 76 connected to the upper surface 74A of the table 74. The refuel tank 72 is disposed on the upper surface 74A of the table 74. The light source 18 is connected to a support 78 connected to a lower surface 74C of the table 74. A computer is connected to each of the controllers 22B, 22C and 22D to control operation of each of the controllers. Alternatively, the 3D printing system can be disposed in any suitable configuration.

### General Interpretation of Terms

The controllers 22B, 22C and 22D preferably include a microcomputer with a control program that controls the components as discussed above. The controllers 22B, 22C and 22D can also include other conventional components such as an input interface circuit, an output interface circuit, and storage devices such as a ROM (Read Only Memory) device and a RAM (Random Access Memory) device. The microcomputers of the controllers are programmed to control the components as discussed above. The memory circuits store processing results and control programs such as ones for operation that are run by the processor circuit. The controllers are operatively coupled to the respective components in a conventional manner. The internal RAM of the controllers stores statuses of operational flags and various control data. The internal ROM of the controllers stores the information for various operations. The controllers are capable of selectively controlling any of the components of the control system in accordance with the control program.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the calibration tool for a three-dimensional printing system. Accordingly, these terms, as utilized to describe the present invention should be interpreted relative to a vehicle equipped with the calibration tool for a three-dimensional printing system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A three-dimensional printing system comprising:
a tank containing a liquid photopolymer resin;
an arm configured to be movable relative to the tank;
a rigid base connected to the arm;
a light source configured to emit light to the tank to form an object on the rigid base; and
a calibration tool connected to the tank, the calibration tool being configured to facilitate calibration of at least one of the tank and the arm.

2. The three-dimensional printing system according to claim 1, wherein
the calibration tool includes a calibration plate removably connected to the tank and a calibration support member removably connected to the arm.

3. The three-dimensional printing system according to claim 2, wherein
the calibration support member is moved with respect to the calibration plate to detect a position of the calibration support member to calibrate the arm.

4. The three-dimensional printing system accordingly to claim 3, wherein
the calibration plate is attachable to the tank in a plurality of positions to increase a number of positions of the calibration support member measurable with respect to the calibration plate.

5. The alignment system according to claim 4, wherein
the calibration tool includes a plurality of datum balls.

6. The alignment system according to claim 5, wherein
the calibration plate detects a position of each of the plurality of datum balls when detecting the position of the calibration tool.

7. The three-dimensional printing system according to claim 2, wherein
the calibration plate is kinematically coupled to the tank.

8. The three-dimensional printing system according to claim 7, wherein
a plurality of spherical members are connected to an upper surface of the tank.

9. The three-dimensional printing system according to claim 8, wherein
a plurality of openings are disposed in the calibration plate, each of the plurality of openings being configured to receive one of the plurality of spherical members.

10. The three-dimensional printing system according to claim 9, wherein
a pair of dowel pins extend through each of the plurality of openings, the dowel pins extending in a direction substantially perpendicular to a longitudinal axis of the opening, the spherical member being configured to contact the pair of dowel pins when the calibration plate is kinematically coupled to the tank.

11. The three-dimensional printing system according to claim 1, wherein
the tank is connected to a platform; and
the calibration tool includes an actuator, the actuator being disposed between the platform and the tank, the actuator being configured to adjust a first position of the tank.

12. The three-dimensional printing system according to claim 11, wherein
the actuator includes
a lower base connected to the platform;
an upper base connected to the tank; and
a plurality of legs extending between the lower base and the upper base.

13. The three-dimensional printing system according to claim 12, wherein
each of the plurality of legs is movable along a longitudinal axis of the leg.

14. The three-dimensional printing system according to claim 6, wherein
each of the plurality of legs is rotatable about a first axis and a second axis, the first axis being different from the second axis.

15. The three-dimensional printing system according to claim 14, wherein
each of the plurality of legs is rotatable about a third axis, each of the first axis, the second axis and the third axis being different axes.

16. The three-dimensional printing system according to claim 12, wherein
the lower base has a first opening and the upper base has a second opening, the first opening being aligned with the second opening.

17. The three-dimensional printing system according to claim 13, wherein
the light source is configured to emit light to the tank through the first opening and the second opening in the alignment actuator.

18. The three-dimensional printing system according to claim 11, wherein
a camera is configured to be removably connected to the arm, the camera being connected to the arm when the rigid base is not connected to the arm, the camera being configured to detect the first position of the tank and a second position of the light source when the camera is connected to the arm.

19. The three-dimensional printing system according to claim 18, wherein
the actuator is configured to adjust the first position of the tank based on the detected first and second positions.

20. The three-dimensional printing system according to claim 19, wherein
the actuator is configured to adjust the first position of the tank when the rigid base is connected to the arm to facilitate flow of the liquid polymer resin in the tank.
